(19) United States
(12) Patent Application Publication
(10) Pub. No.: US 2010/0013125 A1
(43) Pub. Date: Jan. 21, 2010

(54) AFTERCOOLING APPARATUS AND METHOD FOR AFTERCOOLING PREFORMS

(75) Inventor: STEFAN BOCK, Glarus (CH)

Correspondence Address: HENRY M FEIEREISEN, LLC;HENRY M FEIEREISEN, 708 THIRD AVENUE, SUITE 1501, NEW YORK, NY, 10017, US

(73) Assignee: Netstal-Maschinen AG, Naefels (CH)

(21) Appl. No.: 12/523,452

(22) PCT Filed: Jan. 25, 2008
(86) PCT No.: PCT/EP2008/050840

§ 371 Date: Jul. 16, 2009

(30) Foreign Application Priority Data
Jan. 25, 2007 (CH) 121/07
May 9, 2007 (CH) 757/07
Sep. 18, 2007 (CH) 1452/07

(51) Int. Cl. B29C 35/16

(52) U.S. Cl. 264/348; 425/445

(57) ABSTRACT

The invention relates to a device and a method for finishing and calibrating preforms (10) which are removed from a multiple injection tool in an unstable shape, and proposes an air cooler integrated into the water cooled cooling sleeves (21) for the outer side of the open end face of the preform (10). Particularly in the case of special preform varieties, the areas which are unsupported in the cooling sleeves (21) can be pre-strengthened on the outside, from the beginning of the transfer from the open molds (8, 9) to the removing and cooling sleeves, respectively, by means of a cooling which uses cooling air or low-temperature air. With the novel solution, the highest quality can be assured, in particular with respect to dimensional stability and the absence of pressure points under load, by means of a calibration in the cooling sleeves (32) and the treatment in the area of the aftercooling.

### TECHNICAL FIELD

The invention relates to an aftercooling apparatus for preforms, with the still dimensionally unstable preforms being removed from the open mold halves of an injection molding machine by means of a removal gripper and allowed to at least partially aftercool in water-cooled removal or cooling sleeves.

The invention further relates to a method for aftercooling preforms with a threaded portion, a blow-molded part and a neck ring which can be at least partially aftercooled in water-cooled cooling sleeves while still being in a hot, dimensionally unstable state.

### STATE OF THE ART

In practical applications, three aftercooling systems have attained dominance for the production of preforms:
According to a first concept, the still hot preforms are transferred directly to the cooling sleeves of an aftercooling. The aftercooling has several cooling positions commensurate with the number of preforms of an injection molding cycle,
According to a second concept, the preforms are removed from the open molds using a lightweight removal robot which does not provide cooling, and are then transferred to an aftercooling where they are aftercooled.
According to a third concept proposed by the applicant, the robotic function is divided into a removal gripper with water-cooled removal sleeves and an additional transfer gripper for transfer to an aftercooling.

According to recent developments, the injection molding machine cycle time is further shortened by removing the preforms from the molds in a soft state with an unstable shape. However, previously less noticeable problems are now becoming more important. Physical effects cause cooling inside the walls of the preforms to be uneven:
When the preforms are removed from the open molds, thermal stress and shrinkage stress occur in the preforms due to temperature difference inside the preforms, in particular in the wall of the preforms, which causes dimensional changes.
Each mechanical intervention and each handling by robotic grippers can cause dimensional damage.
The same applies when the preforms are in a horizontal position in the aftercooling.

Accordingly, each intervention during aftercooling becomes an extremely delicate task. In the fabrication of injection-molded parts with injection molding machines, the cool-down time is a determining factor for the duration of a full cycle. The first and main cooling effect still takes place in the injection molds. Both mold halves are intensely water-cooled during the injection molding process, so that the temperature of the injection-molded parts, while still in the mold, can be lowered at least in the marginal layers from, for example, 280° C. to a range of about 70° C. The temperature drops in the outer layers very quickly below the so-called glass-transition temperature of about 80° C. The actual injection molding process up to the removal of the injection-molded parts could recently be cut almost in half, while retaining optimal qualities of the preforms. The preforms must be solidified in the mold halves to a degree that they can be gripped by the removal aids and transferred to a removal device. The shape of the removal device matches the outside dimension of the injection-molded parts. The intense water cooling in the mold halves causes, according to physical principles, a time delay of the temperature drop reaching the core region of the preform wall. Accordingly, the aforementioned about 70° C. cannot be uniformly attained across the entire cross-section. As a result, rapid re-heating over the material cross-section occurs from the inside to the outside as soon as the intense water cooling through the molds is interrupted. For two reasons, it is therefore most important to aftercool the preforms outside the mold. Dimensional changes, but also surface damage, such as pressure points, etc., during aftercooling must be prevented. Cooling in the higher temperature range must also be prevented from being too slow to avoid locally detrimental crystal formation caused by reheating. The goal is a uniform amorphous state in the material of the finished preform. The residual temperature of the finished preforms should be so low that no pressure or adhesion damage occurs at the contact points even in large packages with thousands of loosely supplied injection-molded parts. The surface temperature of the finished injection-molded parts must not exceed 40° C. even after slight reheating. Aftercooling after removal of the hot, dimensionally unstable preforms from the injection mold is very important for maintaining dimensional stability.

In WO 2004/041510, the applicant proposes an intense cooling station and an aftercooling station, with the intense cooling station having cooling pins that can be inserted into the preforms for cooling the inside. The interior shape of the cooling sleeves is here matched to the corresponding interior shape of the injection mold, such that the preforms after removal from the molds can be inserted with as little play as possible until completely contacting the cooling sleeves. If the preforms are in a horizontal position in the first aftercooling phase, then they tend to on a corresponding bottom part of the cooling sleeve. The preforms are then cooled more strongly at the bottom due to a more intense cooling contact in the lower region, which induces stress in the preform, causing the preform tends to assume an oval shape. If individual preforms are easily deformed during the first aftercooling phase due to the shortened cooling time in the injection molds, then the corresponding dimensional changes in already solidified preforms can no longer be corrected. According to a preferred embodiment disclosed in WO 2004/041510, an inflation pressure can be generated inside the preforms through targeted control of suction and blow air, and the not yet solidified preform can be brought into complete contact to the entire inner wall surface of the cooling sleeve. After the preforms fully contact the inner wall surface of the cooling sleeve, the contact across this area is maintained during several seconds, producing a calibration effect for each individual preform. The calibration effect produces a high production and quality standard during the production of the preforms that was not attainable with conventional technology. The preforms are thereby brought again to the exact dimensions shortly after being removed from the injection molds. Any dimensional changes introduced after the first critical handling from the injection molds into the cooling sleeves are compensated. Calibration of the preforms allows removal of the preforms from the molds at still higher temperatures, thereby shortening the injection molding cycle time even further.

WO 2004/041510 proposes two different solutions for producing an inflation pressure. According to a first variant, a sealing ring is arranged on a cooling pin or on a blow nozzle, which is brought into contact on the conical transition in the interior of the preform. According to the second variant, the blow nozzle has ring-shaped seals intended for contacting the end face of the open rim of the preform. The inflation pressure hereby operates on the entire preform. Both solutions disadvantageously require in practice and with multiple injection molds having, for example, 100 to 200 mold cavities very high precision for guiding and moving all blow nozzles.

EP 900 135 proposes a concept similar to the aforementioned second variant. Sealing of the open rim presumes a certain pressing force and also sufficient dimensional stability of the threaded part. To prevent dimensional changes of the threaded part, the preforms must be left in the injection molds until reaching a higher dimensional stability. However, this works against shortening the injection molding cycle time.

Based on extensive investigations, it was recognized that calibration of the still hot, dimensionally unstable preforms immediately after withdrawal of the removal robot from the open mold halves has significant advantages. However, this success was not observed with all types of preforms. For example, with preforms having an unsupported threaded region in relation to the cooling sleeves, the problems with dimensional stability could not be solved. The inventor has recognized that with increasingly shorter machine cycle times, the entire open end side can be subject to a significant handling risk during aftercooling, and not only because the threaded portion protrudes from the cooling sleeve and can therefore no longer be cooled by the cooling sleeve. This happens regardless if the preform is calibrated or not.

It is therefore an object of the invention to develop a method and an apparatus which ensures highest quality parameters and maximal dimensional stability of the preform during aftercooling, in particular with respect to handling, at least with typical preforms, and provides the shortest possible cycle time.

### SUMMARY OF THE INVENTION

The aftercooling apparatus according to the invention is characterized in that blowing devices are integrated in the cooling sleeves in the region of the outer open end sides of the preforms, through which the outer skin, at least of an unsupported region of the preforms, can be solidified with cooling air.

The method of the invention is characterized in that the outer skin, at least of a part of the outer open unsupported end sides of the preforms, are cooled with cooling air through air blowing devices integrated in the cooling sleeves and thereby solidified.

The inventor has recognized that calibration after insertion of the hot preforms into the cooling sleeves with a substantially cylindrical or slightly conical blow-molded part results in significant progress in the manufacture of conventional preforms. The interior space of the preform, at least of the blow-molded part, must be mechanically sealed for calibration. However, the force of the compressed air used for the calibration, as well as the mechanical sealing force, creates new problems, if the region of the open end of the preform wall sections is not supported by the inner wall of the cooling sleeves. It is also important to note that the outside of the open end of the preform can already be solidified immediately after transfer from the open mold halves to the cooling sleeves, as soon as the air cooling is integrated in the cooling sleeves. This produces a time improvement of, for example, 1 to 2 seconds to make the respective threaded region dimensionally stable by additionally cooling the outside with cooling air. Cooling the blow-molded part immediately from the outside could be disadvantageous because the calibration would then require a higher air pressure. Water-cooling the cooling sleeves has an immediate effect in the cylindrical region of the neck ring due to the direct wall contact, which turned out to be successful from the beginning. The entire region of the neck ring should be air-cooled and solidified from the outside until the mechanical forces can no longer impair dimensional stability due to the sealing forces. In a particular preferred embodiment, the outer air cooling location for calibration is selected to be located approximately vis-à-vis the inside sealing force of the compressive or sealing rings.

The novel aftercooling solution for calibration and/or handling starts preferably with the concept of a Thermos bottle closure. Both applications have a sensitive wall material. In one case, the material is glass, in the other case an easily deformable plastic. With the solution according to the invention, the sealing location need not be defined with the highest precision. The substantial advantage of the novel invention is that the entire cycle time can be substantially reduced, while meeting all quality criteria and while the efficiency of the injection molding machine can be increased by between 15% and 20%. The preforms can be unmolded sooner, i.e., when the preforms are still substantially dimensionally unstable.

In practice, there are a large variety of preforms which may require special treatment.
Particularly delicate are preforms which have a conically tapered neck piece between the cylindrical blow-molded part and the neck ring.
Another delicate preform has in a widened portion in the corresponding neck section.

With the new invention, dimensional stability can be fully maintained even when the dry cycle time is significantly shortened. This means that a reserve remains for a still shorter machine cycle time when the particular air cooling of the outer, open end side is employed. Field tests have shown that the machine cycle time can be reduced by 15% with clear preforms and by 20% with colored preforms.

The novel invention enables a number of particularly advantageous embodiments. Reference is made here to claims 2-17 and 19-29.

Advantageously, when calibrating, the pressure of the compressed air increases continuously from the start of the calibration. In this way, shrinkage can be continuously compensated even when the preform continues to solidify. Preferably, the compressed air supply can be reproducibly controlled by a programmed increase of the control voltage of a control valve and a corresponding increase of the calibration pressure.

In a particularly preferred embodiment, a cooling aggregate is associated with the aftercooling apparatus for producing low-temperature air, in particular at a temperature below 0° C. A pressure generator for the cooling air is associated with the aftercooling apparatus, which generates a cooling air pressure of less than 2 bar, preferably less than 1.2 bar. Advantageously, the application is controlled, wherein the aftercooling apparatus includes a controller by which the air blowing device can be activated immediately, from the moment the preform is transferred to the removal or cooling sleeves. Application of low-temperature air has two significant advantages: firstly, immediately after transfer of the preforms, which are removed from the molds while still hot, an immediate and more intense solidification of the outer skin can be attained in the region of the opening. This means that before any mechanical intervention through handling or calibration, this region which is especially at risk, is solidified to a degree so as to prevent an oval shape or local swelling. The low-temperature air advantageously also reduces the quantity of cooling air. The air pressure can be reduced, for example from 4 bar to only 1 bar. Accordingly, the same effect can be attained with a much smaller air quantity than with ambient air. In particular, the quantity and temperature of the low-pressure air can be purposely controlled.

According to a particularly advantageous embodiment of the novel invention, it is proposed that the air blowing device is implemented as air channels directed to the outer, open-ended side of the preforms. Preferably, the aftercooling apparatus includes a controller for switching the apparatus on and off, by which the air blowing device can be activated from the moment the preform is transferred to the removal or cooling sleeves as well as during the calibration phase. The solution of the invention can be applied in the field of aftercooling wherever there is a risk of handling-related damage.

In a particularly advantageous embodiment, a gripper has a plurality of nipples with a corresponding insertion part into the preforms, wherein the insertion parts of the nipples have radially expandable compressive or sealing rings which can be inserted into the preforms. The compressive rings are preferably implemented as a radially expandable sealing rings, by which a sealing force can be generated via a bore in the nipples in the interior of the blow-molded part of the preforms directed towards the inner wall of the preforms for building up an inflation pressure. In a particularly preferred embodiment, the inflation pressure is controlled by starting with a minimum pressure, which then increases to the optimal pressure.

According to another important concept of the invention, the nipples can be inserted into the preforms, with control of their position, to a selectable optimal sealing location in the region between the threaded part and the blow-molded part. Different shapes of the transition between the threaded part and the blow-molded part can then be taken into consideration. The best sealing location is identified at the beginning of each production. After insertion of the nipples, the outer wall of the entire blow-molded part of the preform must be in wall contact with the corresponding inner wall of the removal sleeve. Preferably, the preforms are already inserted into the removal sleeves during transfer with the removal sleeves until a complete and full inner wall contact of the entire blow-molded part, including the closed bottom part, is attained. During the duration of several injection molding cycles, the preforms are aftercooled in the water-cooled cooling sleeves of an aftercooling, wherein the calibration is performed during the time of a single injection molding cycle or limited by the duration of a single injection molding cycle. The preforms can be removed from the cooling sleeves without any problems.

With respect to the apparatus, each nipple has two tubular parts which can move relative to one another. A support shoulder is fixedly attached at each end. With the two aforedescribed solutions, each nipple includes air channels through which compressed air can be controllably supplied into the interior space of the blow-molded parts of the preforms. The actuating plate is moved by controlled actuating means with respect to the platform for synchronous activation of the compressive or sealing rings. The actuating means have only a supporting function during the calibration. The compressive or sealing rings, when compressed, are held at the inside of the preform. A small force of the actuating means for the actuating plate is already sufficient for providing a good seal. Advantageously, the nipples are arranged on a platform by way of a common actuating plate, by which the nipples are inserted in or withdrawn from the preforms as well as positioned inside the removal sleeves. To this end, controlled drive means are associated with the platform for positioning the compressive or sealing rings with an optimal insertion depth or at an optimal location.

According to a preferred embodiment, the preforms are removed from the removal sleeves and transferred to cooling sleeves of an aftercooling when reaching sufficient dimensional stability, but within the time of a single injection molding cycle. After calibration, the compressive or sealing rings can be released and the pressure relieved from the interior space of the blow-molded parts. A vacuum can be generated via the air channels and the nipples, with the preforms being transferred to the aftercooling by way of the nipples. The nipple does not have a cooling function. Preferably, during the short calibration time, no air is exchanged between the interior of the preform and the ambient air. The nipples are provided with air channels, through which a vacuum can be generated in the preforms for removal of the preforms. The air channel for compressed air and suction can be identical inside the nipple. Preferably, the tubular sections are movable inside one another, wherein the inner tubular section has at least one air channel. For the concept of the first solution approach, the apparatus has a controllable removal gripper with a number of removal sleeves, with the number of removal sleeves corresponding to at least the number of injection positions of the injection mold. The apparatus has an air connection for controllable admission of compressed air to produce an inflation pressure inside the preforms for calibrating the preforms, as well as a fitting to control suction, whereby after switching from inflation pressure to vacuum the preforms can be removed from the removal sleeves with the help of the nipples. With this concept, the apparatus includes, in addition to the removal gripper, an aftercooling and a transfer gripper for transferring or switching the preforms from the removal gripper to the aftercooling, for finish cooling of the preforms, independent of the injection molding cycle.

According to another advantageous embodiment, the apparatus has an aftercooling constructed as a removal robot with a plurality of cooling positions in relation to the injection positions of the injection molds. The preforms to be transferred hot are here inserted into respective unoccupied cooling positions, calibrated, intensely cooled and ejected after finish cooling. The nipples can here support, with controlled and compressed air, the ejection of the finish-cooled preforms from the removal sleeves as well as the transfer to a conveyor belt. According to the second embodiment, the press or sealing rings can likewise be relieved after calibration, the pressure in the interior space of the blow-molded parts can be vented, the nipples withdrawn and held in a waiting position, until the aftercooling is repositioned for a new charge of preforms of the subsequent injection molding cycle.

In both embodiments, the preforms are calibrated with compressed air and the calibration time is limited by the injection molding cycle. Pressing and calibration of the still soft preforms has significant advantages:
Firstly, by firmly pressing the outer skin of the preforms against the inner, water-cooled removal sleeve, maximum heat transfer and maximum cooling effect is ensured.
Secondly, with the calibration, the outside dimensions of the preforms are reestablished exactly and remain intact during the subsequent solidification of the shape.
Thirdly, the physical quality parameters are guaranteed by rapidly crossing of the so-called glass-transition temperature.
Fourthly, by producing of a strongly cooled and solidified outer material layer, sufficient dimensionless stability of the preforms for subsequent handling by the removal sleeves in the cooling sleeves of an aftercooling and the following ejection to a conveyer belt is achieved.

According to another particularly preferred embodiment of the apparatus, the water-cooled removal sleeves have in the region between the threaded portion and the blow-molded part ventilation channels for a corresponding outside cooling of the corresponding preform region, also an air fitting for the ventilation channels. Depending on the geometrical shape of the preforms, the ventilation channels are arranged in the transition region between the threaded portion and the neck ring and/or in the transition region between the neck ring and the blow-molded part. Preferably, the water-cooled removal sleeves are constructed from standardized parts, such that depending on the particular situation, customized guide rings for the ventilation channels for cooling the transition region between the threaded portion and the neck ring and/or the transition region between neck ring and blowing portion can be implemented.

With respect to the method, it is also proposed to employ outside cooling of the preforms with air in the region between the threaded portion and the blow-molded part immediately after transfer of the preforms to the cooling sleeves of the removal gripper until the end of the calibration. Compressive or sealing rings are attached to the nipples for the calibration and preferably introduced in a position-controlled manner into the preforms up to the transition region between the threaded portion and the neck ring or up to the transition region between the neck ring and the blow-molded part. In combination, the preforms are already cooled from the outside after insertion into the cooling sleeves and during the calibration, also from the outside, to the transition region between the threaded portion and the neck ring and/or up to the transition region between the neck ring and the blow-molded part, and solidified. Advantageously, the outer skin of the preforms is more strongly solidified immediately after transfer from the open mold halves to the cooling sleeves, and before the calibration on the critical unsupported portions of the preforms, so that the mechanical gripper forces do not adversely affect on the corresponding regions. With preforms having a widening neck, the transition region between the threaded portion and the neck ring is air-cooled from the outside. The preforms are hereby inserted until the neck rings contact the front face of the cooling sleeves, wherein the cooling sleeves are configured so that a minimum gap, preferably in a range of hundredths of millimeters, remains between the bottom part of the preforms and the corresponding bottom part of the cooling sleeves, which can then be eliminated by the calibration.

### BRIEF DESCRIPTION OF THE INVENTION

The invention will now be described in more detail with reference to several exemplary embodiments.

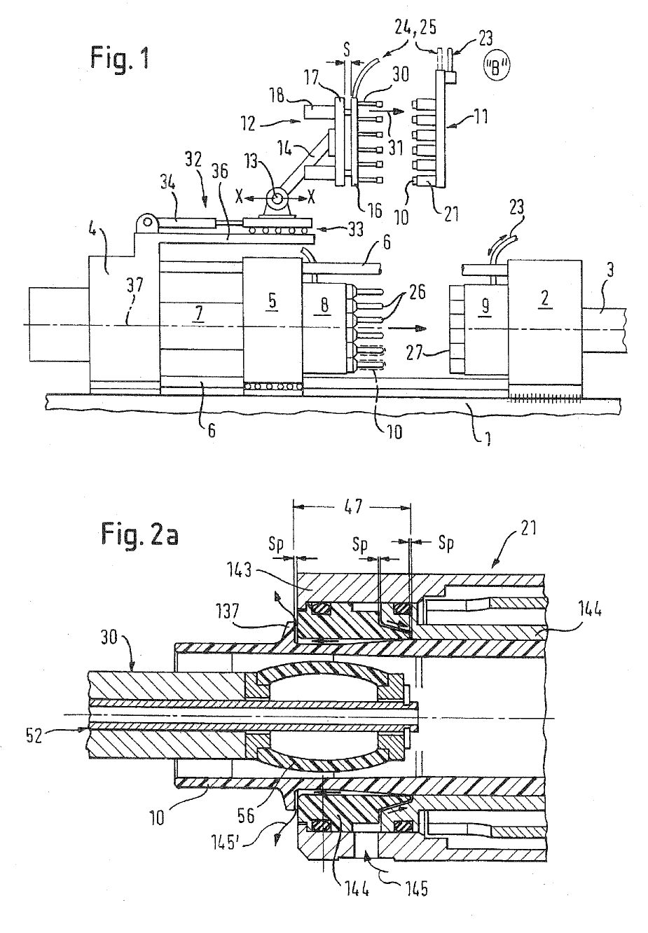

FIG. 1 shows schematically the novel invention in a ready position before calibration of the preforms;

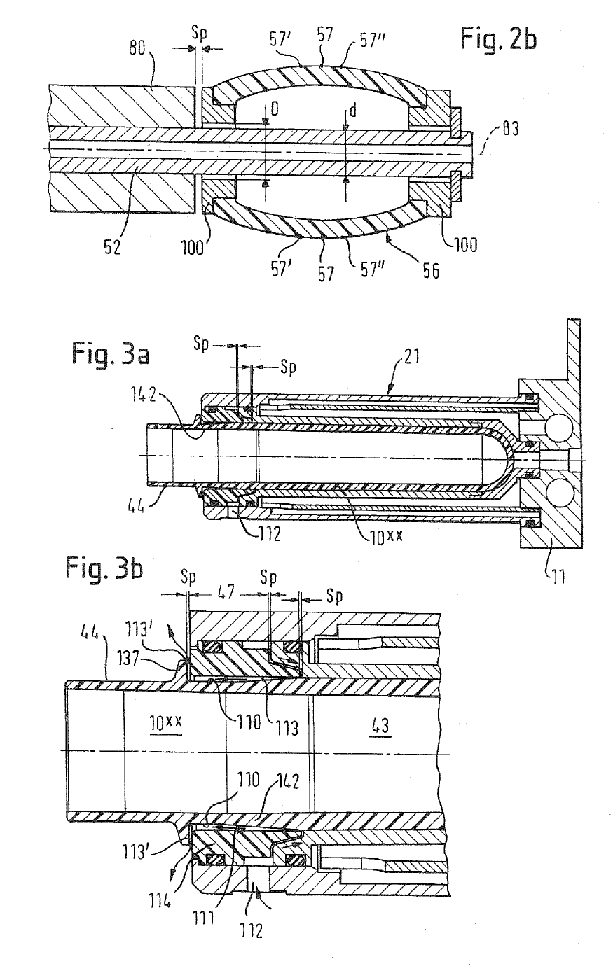

FIG. 2a shows a nipple optimally inserted in a preform in the region of the open end side of the preform;

FIG. 2b shows on an enlarged scale a nipple with a floating compressive or sealing ring;

FIG. 3a shows outside cooling of the transition region between threaded portion and blow-molded part of the preforms;

FIG. 3b shows a partial section of FIG. 3a on an enlarged scale;

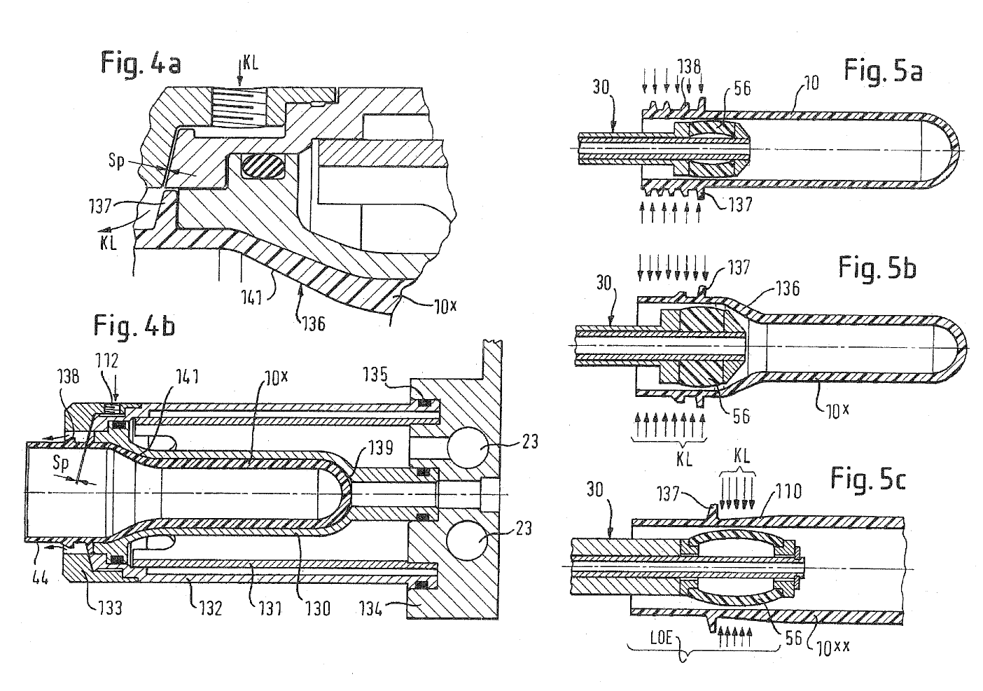

FIG. 4a shows an enlarged portion of external air cooling;

FIG. 4b shows external air cooling in a preform with a widening neck section;

FIGS. 5a, 5b and 5c show once more in schematic diagrams an optimal location for applying the compressive or sealing rings and the exterior cooling, wherein in FIGS. 5b and 5c the delicate, unsupported regions are additionally externally cooled with air;

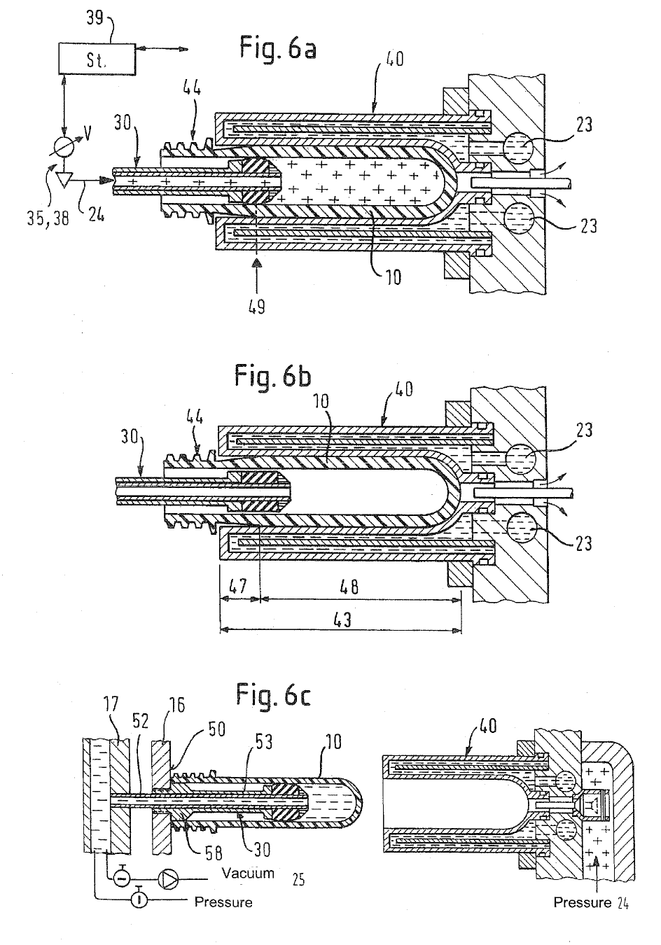

FIG. 6a shows a differently constructed thick-wall preform with corresponding positioning of the nipple and the sealing ring, respectively;

FIG. 6b shows the solution of FIG. 6a, however with the inflation pressure removed and the sealing ring relieved;

FIG. 6c shows removal of a preform with the nipple operating as a support nipple;

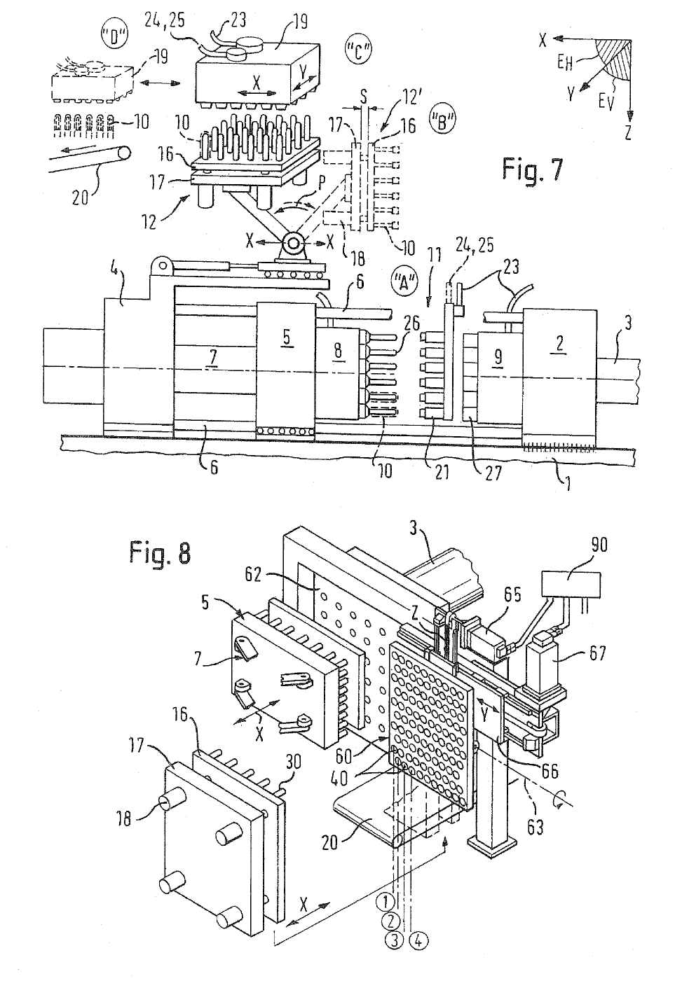

FIG. 7 show schematically an example for the first solution approach with additional aftercooling;

FIG. 8 shows schematically an example for the second solution approach, with the removal robot constructed as an aftercooling;

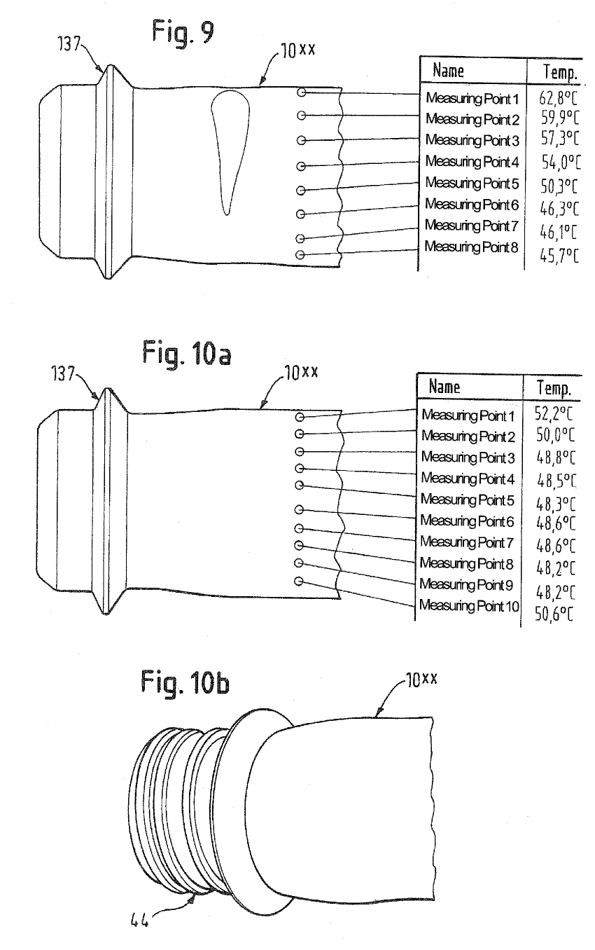

FIG. 9 shows a thermal profile, recorded on a preform produced without calibration;

FIG. 10a shows an exemplary test of a preform calibration; and

FIG. 10b shows a defective preform, wherein the transition region that was not supported in the cooling sleeve, is not solidified according to the invention.

### IMPLEMENTATIONS AND EMBODIMENTS OF THE INVENTION

FIG. 1 shows a situation after retraction of the removal device 11 from the open mold halves 8 and 9 and the start of the calibration as well as of intense cooling. The platform 17 with the nipples 30 is here already in a ready position for insertion travel into the preforms 10 as indicated by arrow 31. The platform 17 is supported on a support console 36 via an arm 14 disposed on a travel device 32 and linear guide rails 33 and is moved parallel to the machine axis 37 with a linear drive 34. The backside of the linear drive 34 is anchored on a bracket of the support plate 4. When the linear drive 34 is activated, the nipples 30 are moved towards and away from the removal device 11 (as indicated by arrow 31). Adjustment means 18, whose sole function it is to squeeze and relieve the compressive and sealing rings 56, are associated with the actuating plate 16.

FIGS. 1 and 7 show schematically an injection molding machine for preforms with the following major elements: a machine bed 1 on which a support platen 4 and a fixed platen 2 and an injection unit 3 are supported. A movable platen 5 is supported for axial displacement on the machine bed 1. The two platens 2 and 4 are connected with one another by tie rods 6 which extend through the movable platen 5. A drive unit 7 for generating the clamping pressure is arranged between the support platen 4 and the movable platen 5. The fixed platen 2 and the movable platen 5 each carry a mold half 8 and 9, respectively, between which a plurality of cavities can be formed for producing a corresponding number of sleeve-like injection-molded parts. The injection-molded parts 10 are produced in the cavities formed between mandrels 26 and cavities 27. After the mold halves 8 and 9 are opened, the sleeves-like injection-molded parts 10 adhere to the mandrels 26. The same injection-molded parts 10 in the finished cooled state are illustrated in the upper left section of FIG. 7, just after being ejected from an aftercooling device 19. The upper tie rods 6 are shown with broken lines to better illustrate the details between the opened mold halves. According to the solution shown in FIGS. 1 and 7, the four process steps for injection-molded parts 10 at the end of the injection molding process according to a first solution approach are as follows:
“A” indicates removal of the injection-molded parts or preforms 10 from the two mold halves. The parts which are still plastic are here received by a removal device 11 (FIG. 1) recessed in a space between the opened mold halves and raised with the removal device 11 into the position “B”.
“B” indicates the phase of the calibration and intense cooling.
“B”/“C” indicates transfer of the preforms 10 from the removal device 11 to a transfer gripper 12, and transfer of the preforms 10 from the transfer gripper 12 to an aftercooling device 19, according to the first solution approach.
“D” indicates ejection of the cooled preforms 10, which are now in a dimensionally stable state, from the aftercooling device 19.

FIGS. 1 and 7 show schematically snapshots of the major handling steps according to the first solution approach. In position “B”, the vertically stacked injection-molded parts 10 are received by the transfer gripper 12 and 12′, respectively, and brought into a vertical position by rotating the transfer device in the direction of arrow P, according to phase “C”. The transfer gripper 12 consists of a platform 17 which can be rotated about an axis 13. The platform 17 carries an actuation plate 16, which are arranged parallel to one another in spaced-apart relationship. The actuating plate 16 can be extended parallel to the platform by a drive or by adjusting means 18, so that in the position “B” the sleeve-like injection-molded parts 10 can be withdrawn from the removal device 11 and placed into the aftercooling device 19 located above in the rotated position “C”. The respective transfer is accomplished by changing the distance “S” between the actuating plate 16 and the platform 17. The injection-molded parts 10, while still hot, are finished-cooled in the aftercooling device 19 and, after the aftercooling device 19 is moved, ejected in position “D” and thrown onto a conveyor belt 20. The reference symbol 23 indicates the water cooling with corresponding supply and drain lines, which are conventional and indicated by arrows to simplify the drawing. The reference symbols 24/25 indicates the air side, wherein 24 refers to blowing in or supplying compressed air and 25 refers to vacuum or drawing off air (FIGS. 6a and 6c).

FIG. 2a illustrates the direct relationship between the function of the nipples 30 as calibration nipples and the conical section 47 of a preform 10. The corresponding conical outer part of the preform 10 is specially cooled immediately after removal from the open mold halves 8, 10, and the unsupported outer wall layer is solidified inside the cooling sleeve 21 (FIG. 3b). This gives the entire preform sufficient dimensional stability at the tapered transition 47. Against the outside, the air guiding ring 114 is held inside the head portion 143 of the cooling sleeve 21. During installation, the air guiding ring 114 with the inner sleeves 144 of the cooling sleeve 21 is inserted from left to right. The cooling air is indicated by arrows 145, 145′. FIGS. 2a and 3b, respectively, show that the cooling air is operative before the compressive or sealing ring 56 makes contact with the preform.

FIG. 2b shows the insertion part of the nipple 30 according to FIG. 6a on an enlarged scale. A particularly preferred feature is the floating support of the compressive or sealing ring 56. The compressive ring 56 is held at both ends by loose support rings 100. The two loose support rings 100 have an inside diameter “D” which is larger than the outside diameter “d” of the support tube 52 by a slight play. Play “Sp” also exists in the longitudinal direction between the support ring 100 and the connecting piece 80. In this way, the compressive or sealing ring 56, when inactive, attains a freedom of movement similar to slight tumbling or floating. This provides automatically an optimal annular sealing location, e.g., 57, 57′ or 57″ on the compressive or sealing ring 56.

FIGS. 3a and 3b show outside cooling of preforms 10xx in the not-uncritical transition 47 between the threaded portion 44 and the blow-molded part 43. Many preforms 10xx have an outer conical taper 110 in this region. This conical taper 110 is disadvantageous because the region 47 of the taper vis-à-vis of the cooling sleeve 21 is unsupported, so that there is no contact with the inner wall 111 of the cooling sleeves. Cooling air can be blown in through an air fitting 112 and vented to the outside through a cooling channel 113. This additional cooling has the significant advantage that it can be effectively used from the first instance when the preforms 10 are transferred to the cooling sleeves 21 and additionally during the entire calibration time. The additional solidification of the outside of the affected preform counteracts a possible deformation caused by the pressing force of the compressive or sealing ring 56. The most striking structural difference to a “normal” cooling sleeve is that an air guiding ring 114 is arranged in the open mouth region. An annular cooling channel is arranged around the corresponding preformed part on the inside of the air guiding ring 114 from the location of the air fitting 112 to the vent location 113′. Cooling air then flows intentionally across the entire conical outside of the preforms to the end face of the neck ring 137.

FIGS. 4a and 4b show a preform 10x with a conically widened neck piece 136. With this type of preform, the widened neck piece is already part of the blow-molded part and contacts during calibration the inner wall of the cooling sleeve 130. The inner wall of the cooling sleeve provides the preform 10x with the defined exterior shape. The entire blow-molded part of the preform 10x makes contact with the neck ring 137. The optimal sealing location of the compressive or sealing ring 56 is in the region of the cylindrical section in the region of the neck ring 137 (FIG. 5b). However, this part is at risk of being deformed during expansion of the compressive or sealing ring 56, because this part is only partially supported from the outside. The additional outside air cooling (KL) becomes therefore important. The outer skin of the thread 44 attains a greater rigidity due to the air cooling of the threaded portion 44 and the neck ring 137, regardless if the preform is calibrated or not.

FIG. 4b shows another interesting conceptual embodiment. The cooling sleeve is constructed of standardized components and consists of an inner cooling sleeve 130, an outer cooling sleeve 131 and a jacket sleeve 132, as well as a head ring 133 which is used to form the air channels (gap Sp). The inner cooling sleeve 130 is designed commensurate with the shape of the preform 10, 10x, 10xx, with a corresponding head ring 133 or 114 being applied. Reference symbol 138 indicates the lowest thread pitch, 134 the base of an actuating plate, and 135 the sealing rings. According to FIGS. 4a and 4b, the cooling sleeve 10x is designed such that after insertion of the preforms into the cooling sleeves, a minimal gap 139 of several tenths of millimeters remains at the bottom part. Conversely, the neck ring 137 should fully rest on the end face of the cooling sleeve already during insertion.

Frequently, as shown in FIG. 5a, external cooling may be unnecessary with a completely cylindrical blow-molded part. Because it is desirable to further shorten the machine cycle time, the threaded portion of preforms with a cylindrical blow-molded part may advantageously be strengthened early on, so as to prevent damage to the thread during any handling in conjunction with aftercooling.

FIG. 5b shows a preform having an increased diameter in the region of the open end. This preform is no longer supported in the cooling sleeve in the region of the neck ring 137 and the thread. Advantageously, the outer skin of the aforementioned region is solidified with cooling air immediately after transfer from the injection molds to a removal gripper.

FIG. 5c shows a solution intended to prevent deformation, in particular bulging of the affected section, when the corresponding blow-molded part is tapered (FIG. 10b), in particular with extremely short cycle times below 10 seconds and with thicker preform walls. The section treated with cooling air is typically between 3 and 5 cm for typical preforms for PET bottles with a fill volume of 1-2 liter, wherein the thread itself has a length of approximately 2 cm.

As seen from the foregoing, the preforms 10, 10x, 10xx have from the moment of the removal from the open mold halves:
Always the best cooling conditions;
The preform is pressed against the inner cooling surfaces of the removal sleeves 40, except for a short interruption, immediately after being moved from the open mold halves to the cooling sleeves until insertion of the nipples 30 during the calibration phase;
The short interruption for a 100% contact of the preform 10 is compensated by the longer calibration;
After calibration, the preforms 10, 10x, 10xx are always dimensionally stable. The preforms 10, 10x, 10xx therefore retain their outside geometric dimensions after calibration until in the finished cooled state.

An effect with maximum intensity is produced by optimizing the design of the water cooling loops
in the injection molds,
in the region of the injection molding cavities and in the injection molding mandrel, as well as
in the removal sleeve,
   The goal is not to finish-cool the preforms 10, 10x, 10xx within a single injection molding cycle. However it is desired to bring the preforms 10, 10x, 10xx to a state at the end of the aftercooling process, which takes about two to three times longer, where they can be poured, stored and transported.

This leads to substantial advantages:
a prerequisite for an extreme shortening of the cycle time,
hence a further increase of the productivity of the injection molding machine,
maximal dimensional stability of the preforms, and
the best possible qualitative properties of the preforms, for example with respect to the crystallinity, dimensional stability and freedom from damage.

FIGS. 6a, 6b and 6c show calibration and removal of the preforms 10 from the removal sleeves 40 with the nipples 30 operating as holding nipples. Vacuum can be applied to the interior space of the blow-molded part through the nipple 30 (FIG. 6a) and the preform 10 is suctioned against the nipple 30 (− sign) according to FIG. 6b. A centering ring 58 which exactly matches the open end of the preform 10 is disposed at the rear end of the support tube 52, for precisely holding the preforms of the nipples 30. On the opposite side of the preform 10, compressed air is applied to the closed end of the preform (+ sign) according to FIG. 6c. The preform 10 strikes a stop 50 on the actuating plate 16 and can be completely removed from the removal sleeve 40 and transferred, for example, to the aftercooling, or ejected according to a second solution approach by switching to compressed air.

FIG. 6a illustrates schematically regulation of the compressed air supply. The compressed air supply for calibration is adjusted via a voltage-controlled control valve 35, 38 by way of the voltage in Volt with controller 39, wherein a continuous increase of the inflation pressure is contemplated, preferably from the start of the calibration. The shrinkage of the preform 10 due to the cooling effect from the cooling sleeve 21 can hereby be compensated and rapid solidification of the outer skin can be attained. The preform 10 can be pressed in an optimal manner against the inner wall of the cooling sleeve for the entire duration of the calibration, without causing bulges in the region of the unsupported regions or damage resulting from handling of the preforms.

FIG. 7 shows a station at the end of the injection process with open mold halves 8 and 9, respectively. The temperature of the preforms 10 was lowered in the mold using a maximum cooling effect. The preforms 10 may still be dimensionally unstable and may quickly be deformed when subjected to the smallest external force, if they are immediately ejected after the mold is opened. At the end of the injection process, the removal device is already in the start position (FIG. 1) and can be lowered between the open mold halves without a time delay after the mold is opened. In the solution illustrated in FIG. 7, an independent aftercooling device in 19 is employed, in which the still hot preforms 10 are finish-cooled during 3 to 4 injection molding cycles. A transfer gripper 12 transfers in phase “B”/“C” of FIG. 7 the preforms 10 to the aftercooling device 19. The preforms are aftercooled in water-cooled sleeves.

Referring back to FIG. 7, the horizontal plane is indicated with EH and the vertical plane with EV. The horizontal plane EH is defined by the coordinates X and Y, whereas the vertical plane is defined by the coordinates Y and Z. The Z-coordinate is oriented vertically and the X-coordinate is oriented perpendicular thereto. The transfer gripper 12 executes a rotation and a linear motion in the X-coordinate. In addition, the transfer gripper 12 can be configured with a controlled motion in the Y-coordinate. Because the transfer gripper 12 already performs a controlled motion in the X-coordinate, the preforms 10 residing on the nipples of the transfer gripper 12 can be exactly positioned in the X-direction by a suitable controlled/regulated movement. For transferring the preforms 10 to the aftercooling 19, the aftercooling 19 is here moved in the X-direction to a fixed position, the transfer gripper 12 is controlled/regulated in the Y-direction and moved to the respective desired position. In the preferred embodiment, the motion means for the aftercooling 19 are controllable/regulatable for the two coordinates X and Y for assuming exact positions for transfer of the preforms 10. The transfer gripper 12 is here set to a fixed transfer position.

The discussions above make reference to the entire disclosure of WO 2004/041510 and PCT 2007/000319.

In the positions illustrated in FIGS. 7 and 8, the two mold halves 8 and 9 are in an open position, so that the aftercooling 60 can move into the unobstructed space 62 between the mold halves. The aftercooling 60 has a total of three movement axes, a horizontal movement axis along the Y-coordinate, a vertical movement axis along the Z-coordinate, and a rotation axis 63, which are coordinated by a machine controller 19. The rotation axis 63 is only used for ejecting the finish-cooled preforms 10 onto a conveyor belt 20. The rotation axis 63 is supported with respect to a base plate. Movement means for vertical movement is a vertical drive 65. The vertical drive 65 is slideably disposed on a base plate 66 of a horizontal drive 67. The horizontal drive 67 has an AC servo motor with a vertical axis. The base plate 66 is supported for back-and-forth movement on two parallel slide rails by way of four sliding bodies. The base plate 66 has on the right side of the drawing a vertical base plate section, on which the vertical drive 65 is anchored. The vertical drive 65 also has an AC servo motor with a horizontal axis.

The aftercooling device according to FIG. 8 has several rows arranged in parallel. In the illustrated example, 12 cooling sleeves 21 are illustrated in a vertical row. The cooling sleeves 21 can be arranged much more tightly with reference to the conditions in the injection molds. Accordingly, not only several parallel rows, but in addition an offset between the rows is proposed. The cooling tubes for a first injection molding cycle are then indicated with numbers 1, for a second injection molding cycles with numbers 2, etc. If in the example with four parallel rows all rows number 3 are filled, then the rows with the number 1 are prepared, as described before, for ejection onto the conveyor belt 20. The remainder is performed in the same way during the entire production time. In the illustrated example, the entire aftercooling time is in the order of three to four times the injection molding time. The air pressure or vacuum conditions in the aftercooling device 19 must be controllable by rows, so that at a certain time all rows 1, or 2, etc. can be activated simultaneously. In addition to the accuracy for controlling the movement of the aftercooling 19 and the platform 17, the acceleration and deceleration functions should also be optimally controlled. Visualization is performed in a command device of the machine controller or the machine computer 90, respectively. Any aspect of the movements can be optimized, for example start and stop, as well as acceleration and deceleration, and speed and distance.

FIG. 9 shows a heat profile, recorded on a preform 10xx, which was produced without calibration. The large temperature difference of 62.8° C. to 45.7° C. is evident. This results in a radial temperature difference of 17.1° C. at the end of the shaft of the preform, which caused an oval outer shape during the first cooling process. This undesired oval outer shape can only be reduced or prevented by a longer cooling time in the mold. In the illustrated example, the illustrated heat profile was measured with a cycle time of 13.5 seconds. The quality was about 0.2 mm, which is just inside the tolerance limit.

FIG. 10a shows an exemplary test where the preform 10xx is calibrated with cooling air. The temperature distribution is in a much narrower range of only 3.9° C., whereby the cycle time was reduced from 13.5 seconds to 11.5 seconds. The eccentricity of the oval shape was only 0.05 mm instead of 0.2 mm. This shows that with the invention, more precise preforms can be produced with a shorter cycle time.

FIG. 10b shows a preform 10xx, where outside cooling according to the invention was not employed. The calibration pressure was too high, so that the preform bulged in the unsupported conical region.

1-29. (canceled)

30. An aftercooling apparatus for preforms; comprising:
a removal gripper for removing a dimensionally unstable preform from an open mold of an injection molding machine;
a water-cooled cooling assembly having a cooling sleeve for receiving the dimensionally unstable preform;
an air blowing device integrated in the cooling assembly in a region of an open end side of the preform and cooling an outside of the preform with cooling air at least in a transition region between a threaded portion and a neck ring of the preform and/or a transition region between the neck ring and a blow-molded part of the preform to thereby at least partially solidify the preform in the transition region; and
a calibration unit constructed to calibrate the preform within a single injection cycle, said calibration unit having a nipple and a compressive sealing ring attached to the nipple, with the nipple constructed for insertion into the open end side of the preform and the compressive sealing ring sealing against an inner surface of the preform proximate to the open end side.

31. The aftercooling apparatus of claim 30, further comprising a controller that activates the air blowing device starting when the preform is transferred to the cooling sleeve.

32. The aftercooling apparatus of claim 31, wherein a quantity of cooling air or a temperature of the cooling air, or both, are controlled so as not to exceed an upper limit, wherein the upper limit are adjusted immediately after the preform is transferred from the open mold to the cooling sleeve.

33. The aftercooling apparatus of claim 30, wherein the cooling sleeve comprises cooling channels disposed in a region between the threaded portion and the blow-molded part, and an air fitting connected to the cooling channels.

34. The aftercooling apparatus of claim 30, wherein the cooling sleeve comprises ventilation channels disposed in the region between the threaded portion and the neck ring or in the transition region between the neck ring and the blow-molded part.

35. The aftercooling apparatus of claim 34, wherein the water-cooled cooling sleeve is fabricated from standardized components, further comprising insertable guide rings for the ventilation channels for cooling the transition region between the threaded portion and the neck ring or the transition region between the neck ring and the blow-molded part.

36. The aftercooling apparatus of claim 30, further comprising a holder having a plurality of nipples for a plurality of preforms, each nipple having an insertion part for insertion into a corresponding preform, with the insertion part having the radially expandable compressive or sealing ring for introduction into the corresponding preform.

37. The aftercooling apparatus of claim 36, wherein the radially expandable compressive or sealing ring is constructed as a floatingly supported sealing ring which produces a mechanically generated, adjustable sealing force directed against an interior wall of the preform, for building up an expansion pressure inside the blow-molded part of the preform.

38. The aftercooling apparatus of claim 37, wherein the nipples are constructed for insertion at a selectable controlled sealing location in a region between threaded portion and blow-molded part.

39. The aftercooling apparatus of claim 36, wherein the perform is transferred, while hot and dimensionally unstable, from the open mold to the water-cooled cooling sleeve and calibrated to an exact outside dimension using compressed air introduced through the nipple inserted into the preform.

40. The aftercooling apparatus of claim 36, further comprising an actuating plate which is common for the nipples, and drive means for insertion and positioning the compressive or sealing rings at an optimal insertion depth or at an optimal location in the preforms or in the cooling sleeve.

41. The aftercooling apparatus of claim 36, wherein the removal gripper comprises a plurality of water-cooled cooling sleeves that correspond in number at least to a number of injection molding positions of the injection mold.

42. The aftercooling apparatus of claim 41, wherein the number of water-cooled cooling sleeves corresponds to between 3-and 4 times the number of injection molding positions in the injection mold.

43. The aftercooling apparatus of claim 30, wherein the removal gripper comprises the water-cooled cooling assembly, wherein the calibration unit is mounted on a transfer gripper, the apparatus further comprising an aftercooling having a number of cooling positions that corresponds to between 3-and 4 times the number of injection molding positions, wherein the blow-molded part of the preform is calibrated in the cooling sleeve, and the perform is transferred within each injection cycle with the transfer gripper in a predetermined exact shape to the aftercooling and—after finish-cooling—to a removal device.

44. A method for aftercooling preforms having a threaded portion, a blow-molded part and a neck ring, comprising the steps of:
inserting a hot and dimensionally unstable preform into a water-cooled cooling sleeve,
at least partially aftercooling the preform in the water-cooled cooling sleeves by cooling an outer skin of at least a part of an outer open unsupported end side of the preform, which includes a transition region between the threaded portion and the neck ring or a transition region between the neck ring and the blow-molded part, with cooling air via an air blowing device integrated in the cooling sleeve, thereby solidifying the outer skin,
withdrawing the water-cooled cooling sleeves from the open mold, and
calibrating the preform within a single injection cycle by way of compressive or sealing rings disposed on a nipple.

45. The method of claim 44, wherein the perform is calibrated on an interior wall of the cooling sleeve to an exact outside dimension by compressed air with continuously increasing pressure.

46. The method of claim 45, wherein the continuously increasing air pressure is attained by increasing a control voltage of a control valve in a compressed air supply.

47. The method of claim 44, further comprising the steps of selecting an optimal sealing location in a region between the threaded portion and the blow-molded part, and inserting with controlled positioning into the preform a nipple with compressive or sealing rings at the optimal sealing location.

48. The method of claim 47, wherein the nipple is inserted in the transition region between the threaded portion and the neck ring or in the transition region between the neck ring and the blow-molded part.

49. The method of claim 44, further comprising the steps of inserting into each of a plurality of preforms compressive or sealing rings disposed on a corresponding nipple with controlled positioning in a region between the threaded portion and the blow-molded part, expanding the compressive or sealing rings for contact with an inner wall of the preform, and sealing an interior space of the blow-molded part to the outside by generating a radial force applied against the inner wall.

50. The method of claims 44, wherein the perform is cooled with the cooling air in the region between the threaded portion and the blow-molded part immediately after transfer of the preform to the cooling sleeve.

51. The method of claims 50, wherein the cooling air is controlled so as to provide a maximum cooling effect immediately after transfer of the preform to the cooling sleeve.

52. The method of claims 44, wherein for a preform having a widening neck, the transition region between the threaded portion and the neck ring is cooled with the cooling air.

53. The method of claims 50, wherein for a preform having neck portion that tapers on the outside, the transition region between the threaded portion and the neck ring is cooled with the cooling air.
